(19) United States
(12) Patent Application Publication
(10) Pub. No.: US 2002/0117213 A1
(43) Pub. Date: Aug. 29, 2002

(54) Silo pressure controller

(76) Inventors: Ronald Vann Stanford, Glen Rose, TX (US); Deryl G. Beakley, Bedford, TX (US)

Correspondence Address: Gerald G. Crutsinger, Esq., Crutsinger & Booth, Suite 1950, 1601 Elm Street, Dallas, TX, 75201, US

(21) Appl. No.: 09/794,375

(22) Filed: Feb. 27, 2001

(51) Int. Cl. G01D 7/00

(52) U.S. Cl. 137/487.5

(57) ABSTRACT

A pressure controller for a storage vessel having an interior chamber into which material is delivered through a fill pipe. A valve is mounted in the fill pipe and controlled by a solenoid valve actuator for closing the valve when a pressure switch, communicating with the interior of the vessel, indicates that pressure in the vessel is excessive.

### TECHNICAL FIELD

The present invention relates to a pressure control system for a vessel used for various applications, especially silos and storage vessels for cement and other potentially air polluting powder materials.

### BACKGROUND OF THE INVENTION

Blowers or air pumps that bulk load powder materials such as cement, fly ash, and lime into storage vessels can create pressures that can damage the vessels. As the powder material fills the storage vessel, it displaces air, which must be vented without loss of the powder material which would result in air pollution.

Conventional overfill control systems, consisting of a closing valve, limit switch and control panel, have been connected to automate silo filling and venting in an attempt to prevent overfill and resulting damage. Overfill control systems are designed to operate on any pneumatic silo filling system with any number of fill pipes. If the high bin signal is clear when the trucker connects his hose to the fill pipe, a butterfly valve will open and the silo will accept material. When a high bin indicator is activated, an alarm will sound telling the trucker to stop his unloading operation. In 90 seconds the butterfly valve will close, sealing off the fill pipe and making it impossible for the trucker to continue pumping in material.

If a dust collector is mounted to the vessel and the filter media in the dust collector becomes plugged or filled, the air pressure from the bulk filling process can't be relieved therefore damaging the vessel. Some vessels have pressure relief valves, but if the relief valve is actuated from overfilling or excessive pressure, the powder material is released into and contaminates the air.

### SUMMARY OF THE INVENTION

The pressure control system comprises a pressure switch connected to a powder inlet valve connected to a bulk loading pipe or tube. The powder inlet valve is also connected to a contaminated air sensor, a material level indicator switch and a pressure differential switch for sensing the pressure drop across filter media In a dust collector.

The material level indicator switch will activate the powder inlet valve when the vessel is full, thus preventing additional material being loaded into the storage vessel.

If and when the filter media becomes plugged, the pressure differential switch will activate the powder inlet valve thus preventing additional material being loaded into the storage vessel.

If the filter media is broken or torn, the pressure differential switch would not activate and powder dust would escape into the air, but with the contaminated air sensor in place, it would sense the presence of dust particles and in turn would activate the powder inlet valve.

If the pressure differential switch and/or the material level indicator switch is defective, the pressure switch would activate the powder inlet valve, thus preventing more material from entering the vessel thus saving the vessel and preventing the escape of contaminated.

### DESCRIPTION OF THE DRAWING

The drawings of a preferred embodiment of the invention are annexed hereto so that the invention may be better and more fully understood, in which:

FIG. 1 is a diagrammatic view of a silo having the silo pressure controller mounted thereon;

FIG. 2 is a diagrammatic view of a pneumatically actuated pinch control valve in an open position;

FIG. 3 is a cross-sectional view similar to FIG. 2 with the pinch control valve actuated to a closed position;

FIG. 4 is a perspective view of a pressure safety valve;

FIG. 5 is a perspective view of dust collector; and

FIG. 6 is a cross-sectional view through a pressure differential switch;

FIG. 7 is a fragmentary perspective view of a level indicator switch;

FIG. 8 is a cross-sectional view through a pressure switch;

FIG. 9 is a top plan view thereof; and

FIG. 10 is a switch diagram.

Numeral references are employed to designate like figures throughout the various figures of the drawing.

### DESCRIPTION OF A PREFERRED EMBODIMENT

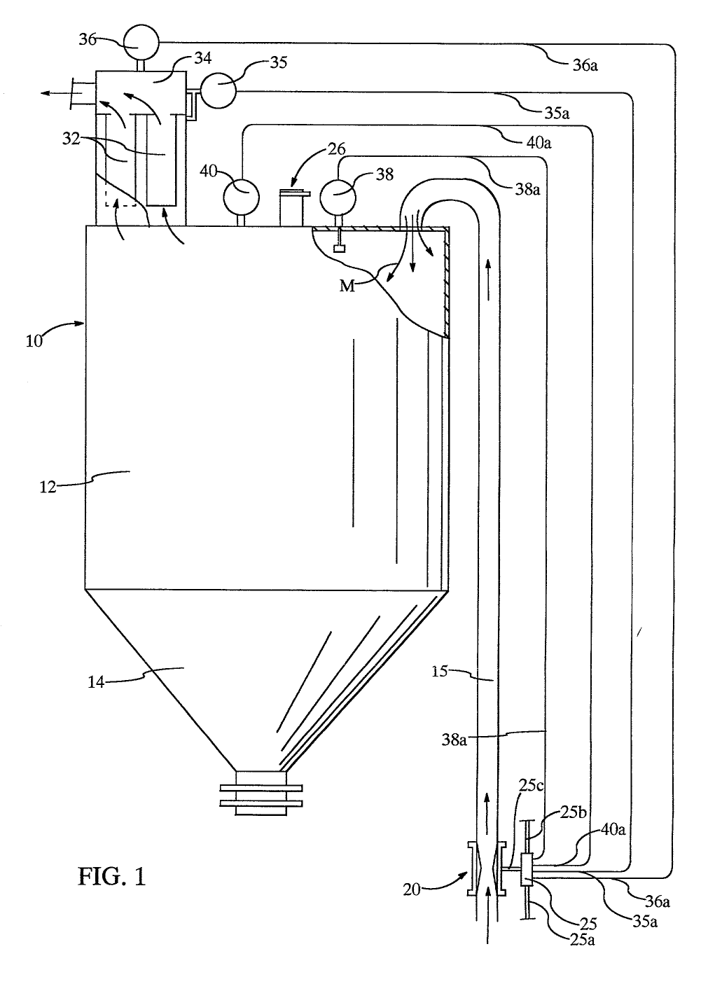

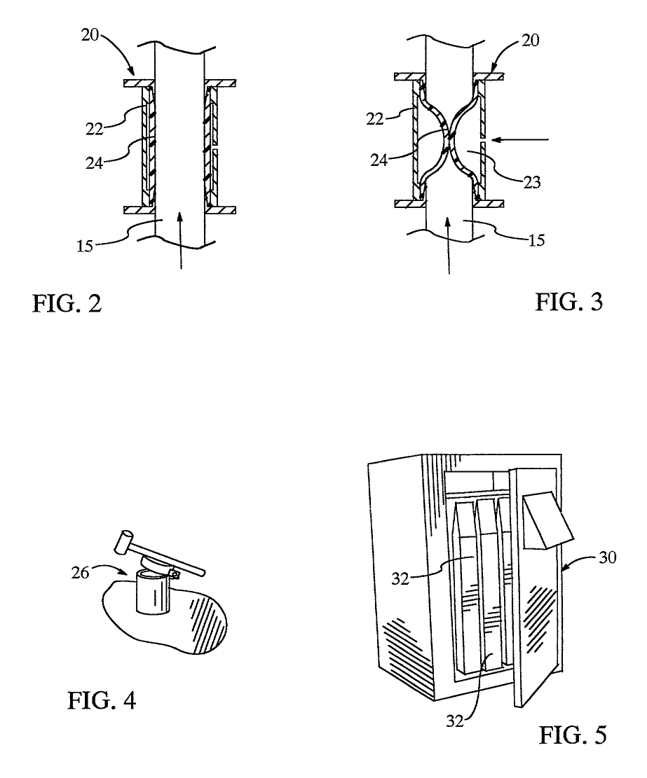

Referring to FIG. 1 of the drawings, a numeral 10 generally refers to a silo having a powder storage vessel 12 mounted above a hopper 14 having a dispenser mounted in the lower end thereof for dispensing powdered material such as cement, fly ash, lime or slurry. Vessel 12 is filled by using pumps or blowers for delivering powder through a fill pipe or tube 15 having a powder inlet valve 20 mounted therein. Referring to FIGS. 1, 2 and 3 of the drawing, the powder inlet valve 20 is a pinch control valve having a valve body 22 and a deformable sleeve 24 mounted therein to form an air chamber 23 between inner walls of the valve body and the outer wall of the deformable sleeve 24.

As best illustrated in FIG. 1 of the drawing, a two-way solenoid actuated valve 25 is connected to an air supply line 25A. Two ports at 25B and 25C of the solenoid actuated valve 25 are arranged such that when the solenoid of valve 25 is actuated, the air supply line 25A is connected through line 25C to the air chamber 23 in valve 20 for actuating the valve to a closed position illustrated in FIG. 3. If an electrical signal is not supplied to the solenoid, air supply line 25A is blocked and air chamber 23 is vented to atmosphere through line 25C and outlet port 25B of solenoid actuated valve 25.

When powder inlet valve 20 is in the open position, powdered material is delivered through fill pipe 15 and dispensed into vessel 12 forming a mound M of powdered material in the vessel. A pressure release valve 26, of the type illustrated in FIG. 4, of the drawing is mounted as illustrated in FIG. 1.

Referring to FIGS. 1 and 5 of the drawing, a dust collector 30 is mounted to vent the vessel 12. As material fills the silo, it displaces air, which must be vented without loss of dust and powder material into the atmosphere. The dust is collected on filter bags 32 and is returned to the vessel 12 by shaking the bags 32 after the filling operation has been completed. Air from silo 12 moves through filter bags 32 into a plenum 34 and is then vented to atmosphere or to other air treatment devices.

A pressure differential switch 35 is connected to sense pressure in vessel 12 and pressure in plenum 34 and to deliver a signal through conductor 35A when the pressure drop across filter bags 32 becomes excessive.

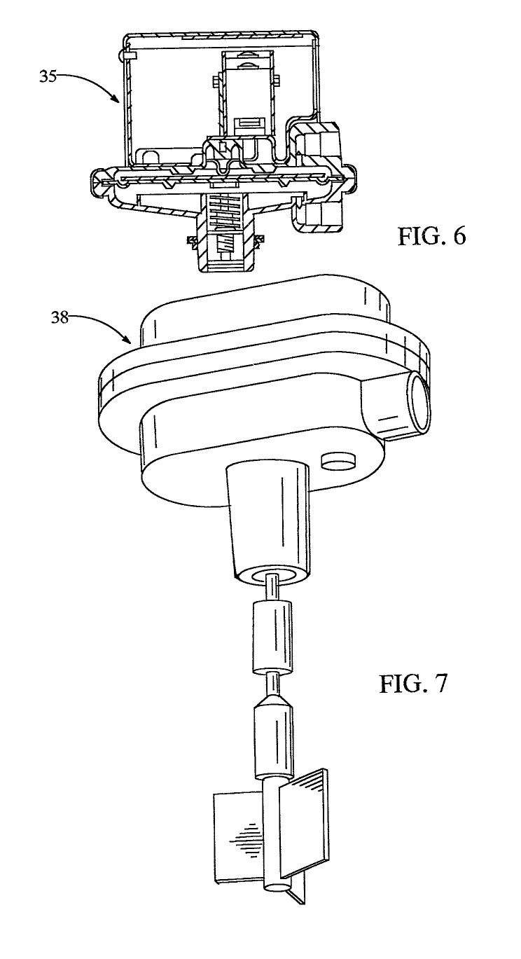

Pressure differential switch 35 best illustrated in FIG. 6, is commercially available from Dwyer Instruments, Inc. of Michigan City, Ind. The differential pressure switch is diaphragm operated with a four inch diaphragm to actuate a single pole, double throw snap switch. Motion of the diaphragm is restrained by a calibrated spring which can be adjusted to set the exact pressure differential at which the electrical switch will be actuated. Motion of the diaphragm is transmitted to the switch button by a direct mechanical linkage. The detailed description of the switch in Dwyer Instruments, Inc.'s Catalog No. 1823, Bulletin E-53 is incorporated herein by reference in its entirety for all purposes.

A contaminated air sensor 36 is connected to plenum 34 and delivers an electrical signal through a conductor 36A to solenoid actuated valve 25. Contaminated air sensor 36 is commercially available from Thermo Ramsey, a division of Ramsey Technology, Inc. of Minneapolis, Minn.

Contaminated air sensor 36 is a non-invasive microwave-based bulk solids flow detector commercially available as “Granuflow GTR 130.” The device is a microwave-based motion detector that detects the Doppler shift of flowing material. A Gunn-diode emits a low power, continuous signal that is reflected by moving material. The device measures the difference between emitted and reflected microwave frequencies. If the return signal has a Doppler frequency shift, then motion is detected.

A level indicator switch 38 illustrated in FIG. 7, is connected through conductor 38A to solenoid actuated valve 25. Level indicator switch 38 is preferably of the type commercially available from Binmaster, a division of Garner Industries, of Lincoln, Nebr.

Level indicator switch 38 incorporates a slow speed synchronous motor that rotates a paddle which senses the presence of material at the level where the paddle is placed. As a high-level control, the paddle rotates continuously when material is not present. When material reaches the paddle, it stops—which actuates a single pole, double throw switch. This de-energizes the motor and may control an audible or visual signal and causes a signal to be delivered through conductor 38A to the solenoid of powder inlet valve 20 for terminating flow through fill pipe 15. A suitable embodiment of the level indicator switch 38 is illustrated in FIG. 7 of the drawing.

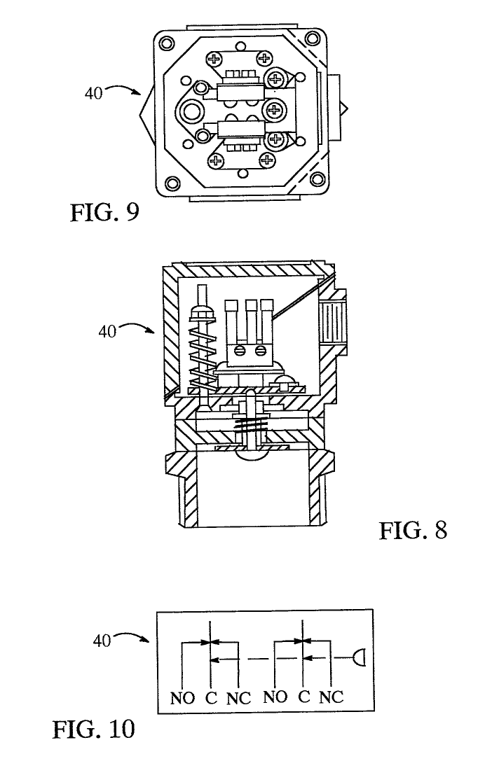

As best illustrated in FIGS. 1, 8, 9, and 10 of the drawing, a pressure switch 40 is connected through conductor 40A to solenoid actuated valve 25.

Pressure switch 40 is preferably a snap-action, electrically actuated switch actuated by a diaphragm or bellows. The force produced by the pressure acts against a lever which is balanced by a pressure adjusting spring. A folded-hinge lever mechanism is preferably a flexible stainless steel leaf spring. Internal stops prevent excessive movement of the lever during an overpressure, while over travel springs protect the electric switches.

Pressure switch 40 is mounted to sense the pressure in pressure vessel 12 and is set to trip at a given level of over pressure, for example, 1.5 pounds per square inch (psi) greater than atmospheric pressure outside of storage vessel 12. A suitable embodiment of pressure switch 40 is commercially available from Salon Manufacturing Company of Chardon, Ohio.

The pressure control system generally comprises pressure switch 40 connected to solenoid actuated valve 25 for shifting powder inlet valve 20 to the closed position in the event that pressure in storage vessel 12 rises to a predetermined pressure. The pressure control system is a redundant backup for the silo filter vent 30 and the level indicator switch 38.

The level indicator switch 38 will actuate the powder inlet valve 20 when the vessel is fill, thus preventing additional material being loaded into the storage vessel 12.

If the filter media 32 becomes plugged, the pressure differential switch 35 should actuate the powder inlet valve 20, thus preventing additional material being loaded into the storage vessel.

If the filter media 32 is broken or torn, the pressure differential switch will not actuate valve 20. However, contaminated air sensor 36 should sense the increased flow of dust and actuate valve 20 for terminating flow into the vessel.

Pressure switch 40 is provided as a backup for the system in the event that pressure in the storage vessel 12 increases to a predetermined level for any reason. Since pressure vessel 12 may be several feet in diameter and several feet tall, a small increase in pressure in the vessel may result in application of very significant forces to walls of the vessel, which may result in rupture of the tressel walls or breaking of rivets at seams in the wall.

The use of pressure switch 40 in combination with solenoid actuated valve 25 and powder inlet valve 20 has particular application in assuring the safe operation of silos which have been in use for an extended period of time or in use under corrosive conditions where precise control of pressure in the vessel is critical.

It should be appreciated that while a preferred embodiment of the invention has been disclosed, other and further embodiments of the invention may be devised without departing from the basic concept of the appended claims.

Having described the invention, we claim:

1. A pressure controller for a storage vessel having an interior chamber into which material is delivered through a fill pipe comprising:
a valve connected to the fill pipe for controlling the flow of material into the storage vessel;
a valve actuator associated with said inlet valve and configured for moving the valve between open and closed positions; and
a pressure switch communicating with the interior of the vessel, said pressure switch being configured to deliver a signal to said valve actuator when pressure in the vessel exceeds a predetermined pressure.

2. A pressure controller according to claim 1, said inlet valve comprising:
a valve body;
a deformable sleeve in said valve body, said sleeve and valve body being assembled to form an air chamber between the valve body and the deformable sleeve; and
wherein said valve actuator comprises a solenoid actuated valve configured to close said inlet valve when actuated by said pressure switch.
